(19) United States
(12) Patent Application Publication
(10) Pub. No.: US 2026/0070425 A1
(43) Pub. Date: Mar. 12, 2026

(54) OVERCURRENT PROTECTION FOR ENERGY STORAGE SYSTEMS

(71) Applicant: Traction HoldCo, LLC, Columbus, IN (US)

(72) Inventors: Sandesh Sadawarte, Pune Maharashtra (IN); Renuka Thota, Telangana (IN); Charushila Kamboj, Uttar Pradesh (IN); Pradheepram Ottikkutti, Pune (IN); Sunil Suryakant Bahulikar, Pune (IN)

(21) Appl. No.: 19/323,355

(22) Filed: Sep. 9, 2025

Related U.S. Application Data
(60) Provisional application No. 63/692,571, filed on Sep. 9, 2024.

(51) Int. Cl. B60L 3/00; B60L 3/04; H01H 71/24; H02J 7/00

(52) U.S. Cl. CPC B60L 3/0092; B60L 3/04; H01H 71/2445; H02J 7/62; H02J 7/663

(57) ABSTRACT

An electrical isolation system for a high voltage battery circuit in an electrified vehicle, the electrical isolation system mounted to a chassis of the electrified vehicle and comprising: an overcurrent protection switch that is configured to be responsive to leakage current present in the high voltage battery circuit by breaking the high voltage battery circuit and a redundant overcurrent protection circuit that is configured to be responsive to leakage current present in the high voltage battery circuit in a manner that is different from the overcurrent protection switch to break the high voltage battery circuit such that the redundant overcurrent protection circuit is more responsive in one or more fault modes of the electrified vehicle than is the overcurrent protection switch alone, wherein the system is included in a control unit of the electric vehicle

### CROSS-REFERENCE TO RELATED APPLICATION

This application claims the benefit of U.S. Provisional Patent Application No. 63/692,571, filed on Sep. 9, 2024, the entire disclosure of which is incorporated by reference herein in its entirety.

### BACKGROUND

Electrified vehicles, such as electric cars and hybrid electric cars, are becoming increasingly popular due to their low environmental impact and fuel efficiency. These vehicles rely heavily on electrical components and systems, including batteries, motors, and power electronics, to provide propulsion and control. However, these electrical components are vulnerable to damage from overcurrent, which can occur due to a variety of reasons, such as short circuits, component failure, or power surges. Overcurrent protection systems ensure the safe and reliable operation of electrified vehicles. Existing overcurrent protection systems have limitations, such as slow response times and limited accuracy in detecting overcurrent events.

### SUMMARY

In example 1, an electrical isolation system for a high voltage battery circuit in an electrified vehicle, the electrical isolation system mounted to a chassis of the electrified vehicle and comprising: an overcurrent protection switch that is configured to be responsive to leakage current present in the high voltage battery circuit by breaking the high voltage battery circuit and a redundant overcurrent protection circuit that is configured to be responsive to leakage current present in the high voltage battery circuit in a manner that is different from the overcurrent protection switch to break the high voltage battery circuit such that the redundant overcurrent protection circuit is more responsive in one or more fault modes of the electrified vehicle than is the overcurrent protection switch alone, wherein the system is included in a control unit of the electric vehicle.

In example 2, further to example 1, wherein the redundant overcurrent protection circuit includes an electromechanical switch to break the high voltage battery circuit.

In example 3, further to example 2, wherein the overcurrent protection switch is controlled by a control system of the electrified vehicle.

In example 4, further example 2, wherein the redundant overcurrent protection circuit includes at least one reed element.

In example 5, further to example 4, wherein the at least one reed element includes a reed relay.

In example 6, further to example 5, wherein the reed relay is normally closed.

In example 7, further to example 5, wherein the at least one reed element includes a first reed element and a second reed element to electrify the first reed element to break the circuit.

In example 8, further to example 5, wherein the redundant overcurrent protection circuit further includes a resistor arranged between a terminal of the battery and the chassis.

In example 9, further to example 1, wherein the redundant overcurrent protection circuit is a first redundant overcurrent protection circuit, wherein the electrical isolation system further comprises a second redundant overcurrent protection circuit, and wherein the high voltage battery circuit further includes an inductor arranged between the first and second redundant overcurrent protection circuits.

In example 10, further to example 9, wherein: the first redundant overcurrent protection circuit includes a first normally closed switch that includes an input side and a power side, the input side is arranged between the inductor and a first battery terminal of the battery, and the power side is arranged between a first chassis-grounded reed element and the chassis; the overcurrent protection switch is arranged between a second battery terminal of the battery and the second redundant overcurrent protection circuit; and the second redundant overcurrent protection circuit includes a second normally closed switch that includes an input side and a power side, the input side is arranged between the overcurrent protection switch and the inductor, and the power side is arranged between a second chassis-grounded reed element and the chassis.

In example 11, further to example 10, wherein the first battery terminal is a positive terminal of the battery, and the second battery terminal is a negative terminal of the battery.

In example 12, further to example 10, wherein the first and second chassis-grounded reed elements are reed relays.

In example 13, further to example 10, further comprising a first chassis-grounded resistor arranged between the first battery terminal and a chassis ground and a second chassis-grounded resistor that is arranged between the second battery terminal and the chassis ground, wherein the first chassis-grounded reed element is a first reed switch that is connected to the first chassis-grounded resistor and the second chassis-grounded reed element is a second reed switch that is connected to a second chassis grounded resistor.

In example 14, further to example 9, wherein the overcurrent protection switch is a first overcurrent protection switch, and wherein the electrical isolation system further includes a second overcurrent protection switch, each of the first overcurrent protection switch and the first redundant overcurrent protection circuit is arranged at a first battery terminal of the battery, and each of the second overcurrent protection switch and the second redundant overcurrent protection circuit is arranged at a second battery terminal of the battery.

In example 15, an energy storage system, comprising: a high voltage battery circuit; and an electrical isolation system for the high voltage battery circuit in the electrified vehicle, the electrical isolation system mounted to a chassis of the electrified vehicle and comprising: an overcurrent protection element that is configured to be responsive to leakage current present in the high voltage battery circuit by breaking the high voltage battery circuit and first and second redundant overcurrent protection circuits that are configured to be responsive to leakage current present in the high voltage battery circuit in a manner that is different from the overcurrent protection switch to break the high voltage battery circuit such that the first and second redundant overcurrent protection circuits are more responsive in one or more fault modes of the electrified vehicle than is the overcurrent protection switch alone.

In example 16, further to example 16, wherein the first redundant overcurrent protection circuit is arranged at a first battery terminal of the battery, and the second redundant overcurrent protection circuit is arranged at a second battery terminal of the battery.

In example 17, further to example 15, wherein the overcurrent protection element is a first overcurrent protection switch, and wherein the electrical isolation system further includes a second overcurrent protection switch, each of the first overcurrent protection switch and the first redundant overcurrent protection circuit is arranged at a first battery terminal of the battery, and each of the second overcurrent protection switch and the second redundant overcurrent protection circuit is arranged at a second battery terminal of the battery.

In example 18, a method of mitigating loss of isolation in a battery circuit of a high-voltage system in an electrified vehicle, the method comprising: responding to leakage current present in the battery circuit by breaking the battery circuit using an overcurrent protection switch in the battery circuit, and responding, independently to the overcurrent protection switch, to leakage current present in the battery circuit by breaking the battery circuit using a redundant overcurrent protection circuit in the battery circuit such that the redundant overcurrent protection circuit is more responsive in one or more fault modes of the electrified vehicle than is the overcurrent protection switch alone.

In example 19, further to example 18, wherein the one or more fault modes in which the redundant overcurrent protection circuit is more responsive than is the overcurrent protection switch alone includes failure of the overcurrent protection switch.

In example 20, further to example 18, wherein responding to leakage current present in the battery circuit by breaking the battery circuit using the overcurrent protection switch includes receiving an indication to open the overcurrent protection switch in response to detecting a leakage current by a battery management system of the electrified vehicle.

### BRIEF DESCRIPTION OF THE DRAWINGS

FIG. 1 is a schematic diagram of a dual-axle multi-mode adjustable hybrid vehicle system with integrated front axle;

FIG. 2 is a schematic diagram of an integrated axle;

FIG. 3 is a schematic diagram of another dual-axle multi-mode adjustable hybrid vehicle system with integrated front axle;

FIG. 4 is a schematic diagram of an example of a three-axle multi-mode adjustable hybrid vehicle system with integrated front axle;

FIG. 5 is a schematic diagram of an example of a three-axle multi-mode adjustable hybrid vehicle system with integrated front axle;

FIG. 6 is a schematic diagram of an example of a three-axle multi-mode adjustable hybrid vehicle system with integrated front axle;

FIG. 7 is a schematic diagram of a controller operatively coupled with other components of the system;

FIG. 8 is a schematic diagram of a battery circuit having an electrical isolation failure safety system;

FIG. 9 is the schematic diagram in FIG. 8 in a first operational scenario;

FIG. 10 is the schematic diagram in FIG. 8 in a second operational scenario;

FIG. 11 is the schematic diagram in FIG. 8 in a third operational scenario;

FIG. 12 is the schematic diagram in FIG. 8 in a fourth operational scenario;

FIG. 13 is the schematic diagram in FIG. 8 in a fifth operational scenario;

FIG. 14 is the schematic diagram in FIG. 8 in a sixth operational scenario;

FIG. 15 shows an alteration to the schematic diagram of FIG. 8;

FIG. 16 shows a schematic illustration of an electrical vehicle battery pack;

FIG. 17 is a flowchart of an overcurrent protection method in an electrified vehicle;

FIG. 18 is a flowchart showing operation of an electrical isolation failure safety mechanism for a battery electric vehicle or a fuel cell electric vehicle;

FIG. 19 is a flowchart showing operation in a failure mode of an electrified vehicle when isolation monitoring is lost;

FIG. 20 is a flowchart showing operation of a mechanical feature of a secondary safety layer for an isolation fault,

FIG. 21 is a flowchart of vehicle operation in a failure mode when isolation monitoring is lost, and

FIG. 22 is a flowchart of a mechanical secondary safety layer that opens the battery circuit in response to detected leakage current.

according to principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electrified vehicles are a type of transportation technology that utilizes electricity as its main source of power. This technology is becoming increasingly popular due to its environmental benefits and cost-effectiveness. Electrified vehicles include fully electric vehicles, hybrid electric vehicles, and fuel cell electric vehicles. Principles of the present disclosure are applicable in whole or in part to each of these vehicles.

Fully electric vehicles are powered solely by electricity and do not require any gasoline or diesel fuel. These vehicles use rechargeable batteries to store energy, which is then used to power the electric motor. Fully electric vehicles are environmentally friendly, producing zero emissions and requiring less maintenance than traditional gasoline-powered vehicles.

Hybrid electric vehicles combine an electric motor with a gasoline or diesel engine. These vehicles use the electric motor for low-speed driving and the gasoline or diesel engine for high-speed driving. Hybrid electric vehicles are more fuel-efficient than traditional gasoline-powered vehicles and produce lower emissions.

Fuel cell electric vehicles use hydrogen as their main source of energy. The hydrogen is converted into electricity through a fuel cell, which powers the electric motor. Fuel cell electric vehicles produce zero emissions and are highly efficient, making them an environmentally friendly option for transportation. However, the infrastructure for hydrogen fueling stations is still limited, making it difficult for fuel cell electric vehicles to become mainstream.

Presently, electrified vehicles are equipped with electrical isolation monitoring systems that are integrated into their system controls module or one or more control systems. However, these systems may encounter electromagnetic interference (EMI) and electromagnetic compatibility (EMC) challenges. These issues can arise when electrical devices interact with one another, resulting in EMI, an electromagnetic disturbance that can corrupt signal quality and cause electronic devices to malfunction. On the other hand, EMC refers to the ability of an electronic system to function in an electromagnetic environment without causing EMI in nearby devices. Due to the presence of multiple power electronics components in vehicles or EMI-EMC issues, controls/software malfunction can occur, leading to the failure of the electrical isolation monitoring system. In the event of a leakage current path to the chassis, the inability to detect isolation fault can result in safety hazards such as an electrified chassis, electrified components of the vehicle, and other similar risks.

Overcurrent protection is a technology used to prevent electrical circuits from being damaged due to excessive current flow. It works by interrupting the flow of current when it exceeds a certain level, which is determined by the rating of the protective device. There are different types of overcurrent protection elements, including fuses and circuit breakers. Fuses are designed to melt and break the circuit when the current exceeds a certain level, while circuit breakers use a switch mechanism to open the circuit when the current goes beyond the rated value. These devices are essential in protecting electrical equipment and preventing electrical fires caused by overloading or short circuits.

A system for overcurrent protection from leakage current in electrified vehicles comprises a plurality of fuses, switches, relays, and reed elements. The fuses are placed in the electrical circuit to prevent excessive current flow and protect the electrical components. The switches and relays are used to control the flow of current and isolate the affected circuit. The reed elements are placed in the electrical circuit and are used to detect the presence of leakage current. When the reed element detects leakage current, it triggers the switches and relays to isolate the affected circuit. The system provides a reliable and efficient solution for overcurrent protection from leakage current in electrified vehicles.

Reed elements are a type of switch that can be used in electrified vehicles to control the flow of electricity. They consist of two metal contacts that are separated by a small gap, and a thin piece of ferromagnetic material (usually made of nickel or iron) that sits in the gap. When a magnetic field is applied to the ferromagnetic material, it becomes magnetized and is attracted to one of the metal contacts, completing the circuit and allowing electricity to flow through. In electrified vehicles, reed elements can be used in a variety of ways, such as to control the charging of the battery or to switch between different power modes. They are often preferred over other types of switches because they are reliable, have a long lifespan, and are relatively inexpensive to manufacture. Additionally, because they are activated by a magnetic field, they can be controlled remotely without the need for physical contact, making them ideal for use in situations where space is limited, or access is difficult.

Principles of the present disclosure provide an additional safety mechanism that can stay dormant during normal controls functioning. In case of control system malfunction, hardware failure (e.g., by a primary contactor) and in case there is electrical isolation fault, the safety mechanism is activated, independently of any control system, and breaks the circuit. Further details about these principles are provided hereinafter.

A multilayered overcurrent protection system as disclosed herein includes a secondary safety layer or an alternative to a primary safety mechanism. The secondary safety layer (or redundant safety layer) operates differently or oppositely from the primary safety layer. For instance, where the primary safety layer is controls based, the secondary safety layer is “non controls” based. The alternative can also be true where the primary safety layer is “non controls” based and the secondary safety layer can be the one that integrates with an existing controls system. Either one of the safety layers can be triggered as the electrified vehicle experiences leakage current in the chassis. Some examples include physics based, hardware based, controls based, and controls independent. Applications can include mobile or stationary applications (e.g., mobile or stationary energy storage systems) that demand a high safety margin. Such an overcurrent protection system is useful in, for example, a scenario where EMI-EMC led to controls malfunction and primary isolation monitoring via the primary safety layer is not working.

Assuming that the primary safety layer is controls based, the secondary safety layer can be controlled only through the leakage current that flows to a ground. In that regard, the secondary safety layer does not have any control connections to it, though this can be connected to the existing vehicle dashboard indicating that there is a leakage current. In examples, the secondary safety layer has no precise timing control. It remains in default close state and will only open when a reed element coil is energized due to leakage current. In all other scenarios, the secondary safety layer can act as a passive component. It is not a permanent opening switch as it returns to a closed state after leakage current disappears.

While a secondary safety layer is additional hardware, it is for a low cost and high benefit. For instance, elements of the secondary safety layer can include a resistor of 1 Mohm, 1 reed relay, and 1 high-voltage relay. For a relevant application, the hardware cost is not considerable, maybe less than $100 USD. In case of series connections of battery modules or packs, a circuit according to principles of the present disclosure could be implemented at a strategic point in the battery pack circuit to protect the entire battery system. This circuit is rated to handle the maximum current expected in the circuit and provide overcurrent protection for the entire system.

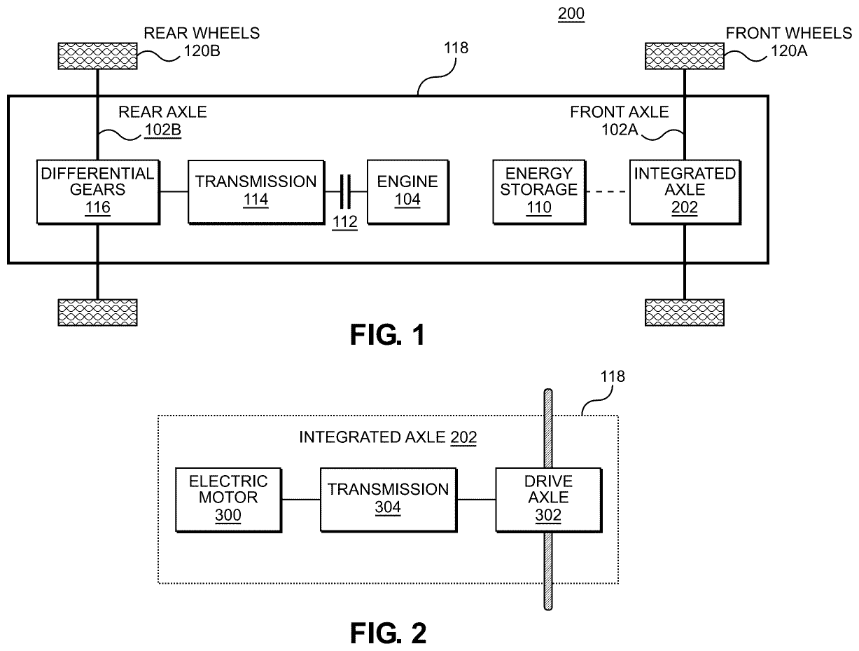

Now turning to the figures, FIG. 1 shows an example of a multi-mode hybrid vehicle system 200 as disclosed herein. The system 200 includes a plurality of motive power sources. For example, an integrated axle 202 is mechanically coupled with a steerable front axle 102A such that the integrated axle 202 is used as a motive power source to provide the motive force to drive the front wheels 120A using electrical energy provided form the energy storage 110. The rear axle 102B is mechanically coupled with the differential gears 116, which is mechanically coupled with the transmission 114, which is mechanically coupled with or decoupled from the engine 104 via the clutch 112. The rear axle 102B, therefore, is controlled using the motive force provided by the engine 104, another power motive source. For simplicity, the inverter(s) for the integrated axle 202 and the fuel reservoir 108 coupled with the engine 104 are not shown.

As disclosed herein, an “integrated axle” includes a type of electric axle drive that is affixed to the wheels to rotate them. In examples, the integrated axle combines the functionality of an electric motor-generator, power electronics such as an inverter, and in some examples a cooling circuit to reduce cost and increase efficiency in a single component. Integrated axles are neither directly nor indirectly coupled with any combustion engine, thereby using solely the motor-generator included therein to provide mechanical power to a drive axle coupled thereto.

In some examples, the motor-generator of the integrated axle may be mounted on the drive axle. In some embodiments, the integrated axle is configured to reduce interfaces and components that may induce efficiency loss. Examples of such components include wires and copper cables that link the components together, plugs, bearings for rotating components, and separate cooling circuits for the electric motor and power electronics. The integrated axles are also more compact than the electric motor, the power electronics, and the cooling circuits therefor being individually installed, thus saving installation space within the chassis frames of the vehicle and allowing more room therein. Each integrated axle is configured independently of other sat(s) in the system. In some examples, the integrated axle may also include a two-speed or three-speed gearbox.

As shown in the embodiment of FIG. 1, the integrated axle 202 is mechanically coupled with a drive axle 102, such as the front axle 102A as shown in FIG. 1. The drive axle 102 is mechanically coupled with a pair of wheels 120, such as the pair of front wheels 120A as shown in FIG. 1. Although not shown, a controller is electrically coupled with the integrated axle 202. Based on the inputs received, the controller turns on (activates or engages) or turns off (deactivates or disengages) one or more of these components to achieve the different modes shown herein. FIG. 2 shows some of the components of the integrated axle 202. For example, the integrated axle 202 includes an electric motor-generator 300, a drive axle 302, and a transmission 304. Other components such as the aforementioned inverter and/or cooling circuit may be included in the integrated axle 202, as suitable. These components are separately or independently operable from the other components (e.g., the transmission 304 is separately operable from the transmission 114). The components of the integrated axle 202 (e.g., the electric motor-generator and at least a portion of the drive axle, etc.) may be mechanically mated to, coupled to, affixed to, or implemented within a common housing 118. The housing may be any suitable structure which supports the positioning of the components, as well as to provide protection of the components.

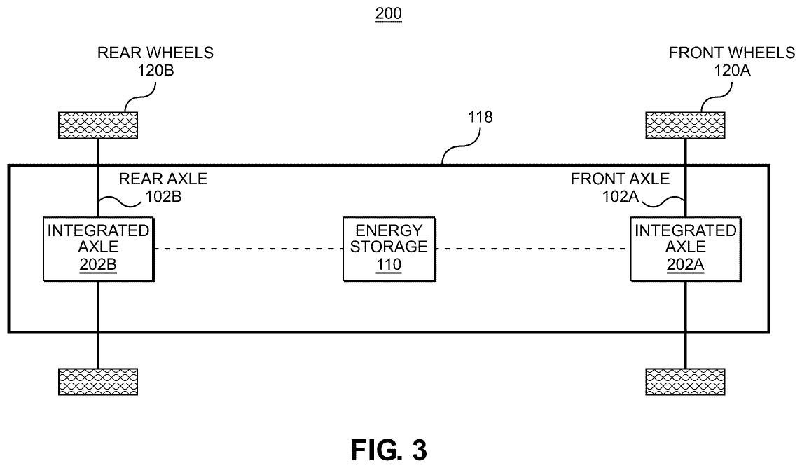

FIG. 3 shows an example of the system 200 which incorporates two integrated axles 202A and 202B, with one implemented for each of the front axle 102A and the rear axle 102B, respectively. The integrated axles 202A and 202B are operated using the controller (not shown) and the electrical energy for these axles are provided by a common energy storage 110, such as a battery or a battery pack. The two integrated axles 202A and 202B may be separately and independently operated so as to be implementable as two separate and distinct motive power sources. Each integrated axle may include the same components, including for example an electric motor and a transmission as explained herein, that are separately operable from each other, although they may be operable together simultaneously as well, as suitably controlled by the controller.

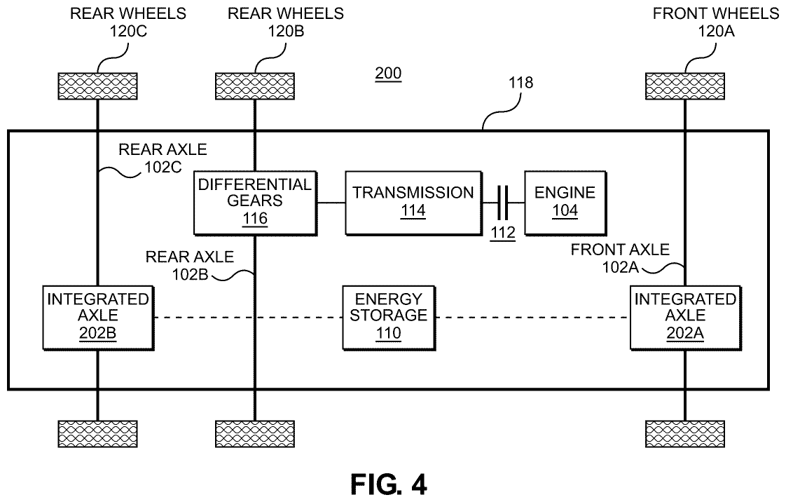

FIGS. 4 through 6 show examples of the system 200 where more than two axles (and in effect, more than four wheels) are implemented, with different combinations of integrated electrical axles and engine-powered axles implemented therein. It is to be understood that these figures are provided for illustrative purposes only, such that any additional number of axles may be implemented according to the need of the vehicle and its operation.

FIG. 4 shows an example of the system 200 which incorporates three axles 102A, 102B, and 102C, of which two of them, the front axle 102A and the rear axle 102C, have integrated axles 202A and 202B, respectively, coupled therewith. The other axle (rear axle) 102B is coupled with the engine 104 via the clutch 112, transmission 114, and differential gears 116 as shown. The integrated axles 202A and 202B are electrically powered by the energy storage 110.

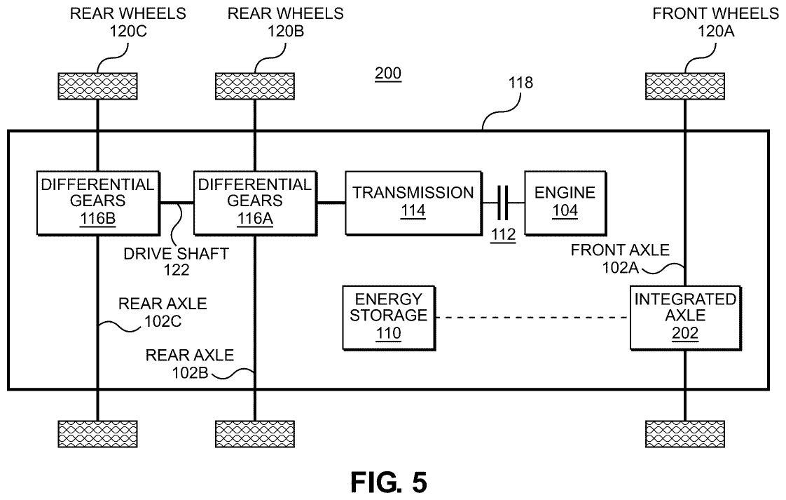

FIG. 5 shows an example of the system 200 with three axles 102A, 102B, and 102C, but instead of two integrated axles, only the front axle 102A is coupled with the integrated axle 202, and the two remaining rear axles 102B and 102C are coupled with differential gears 116A and 116B, respectively. The differential gears 116A and 116B are coupled with each other via the drive shaft 122 which may operate both of the gears simultaneously, using the power provided by the engine 104 and transferred through the transmission 114. As such, the rear axles 102B and 102C may be coupled with each other via the drift shaft 122.

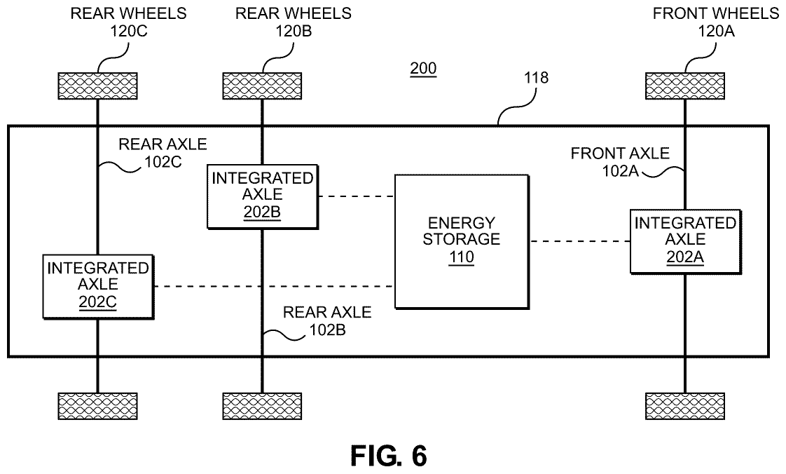

FIG. 6 shows an example of the system 200 with all three axles 102A, 102B, and 102C being powered electrically using the energy storage 110. That is, there are three integrated axles 202A, 202B, and 202C for the three axles, each independently operable, as controlled by a controller (not shown). In all examples disclosed herein, the front axle 102A is always implemented with an integrated axle, but the remaining axles may have integrated axles, engine-powered axles, or a combination of both.

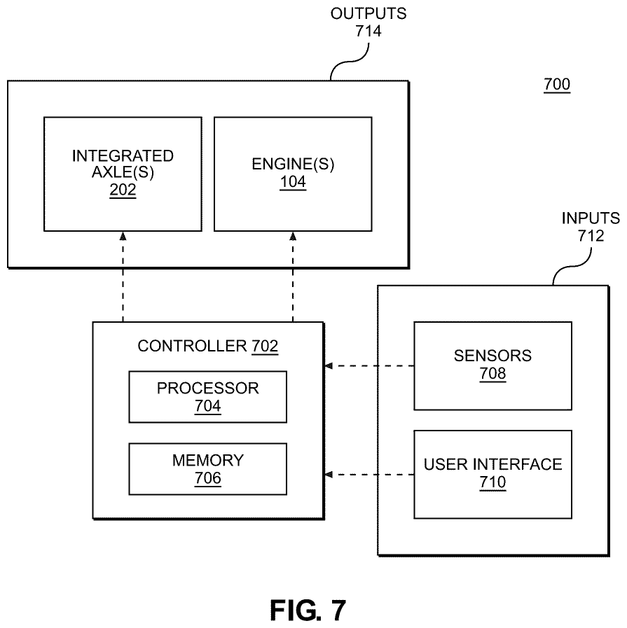

FIG. 7 shows an example of a control system 700 for the multi-mode hybrid vehicle system 200 as disclosed herein. The control system 700 includes a controller (multi-axle system controller) 702 which receives inputs 712 and controls the outputs 714. The controller 702 includes a processor 704 and a memory unit 706. The processor may be a microprocessor, a microcontroller, or any other suitable types of processing device or controller as known in the art. The controller 702 controls the operation of the integrated axle(s) 202 and engines 104 over communication lines, for example. It should be understood, however, that communication between controller and the integrated axle(s) and engine(s) may alternatively, or in addition, be performed wirelessly.

It should be understood that, in some embodiments, the controller 702 may form a portion of a processing subsystem including one or more computing devices having non-transient computer readable storage media, processors or processing circuits, and communication hardware. The controller 702 may be a single device or a distributed device, and the functions of the controller may be performed by hardware and/or by processing instructions stored on non-transient machine-readable storage media. Example processors include an application specific integrated circuit (ASIC), a field programmable gate array (FPGA), a digital signal processor (DSP), and a microprocessor including firmware. Example non-transient computer readable storage media includes random access memory (RAM), read only memory (ROM), flash memory, hard disk storage, electronically erasable and programmable ROM (EEPROM), electronically programmable ROM (EPROM), magnetic disk storage, and any other medium which can be used to carry or store processing instructions and data structures and which can be accessed by a general purpose or special purpose computer or other processing device.

Certain operations of the controller 702 described herein include operations to interpret and/or to determine one or more parameters. The parameters may be inputs 712 which may be information or data received from sensors 708 and/or user interface 710, among other means of providing inputs. The sensors may be any suitable sensor that can measure any change or increase in the load of the vehicle, or the load applied on the vehicle. The sensors may include, but are not limited to, weight sensors which detect the physical weight of the vehicle and/or its cargo, gyroscopes which detect the incline or decline in which the vehicle may be traveling, and altimeters which detect the altitude or change in altitude as the vehicle travels, among others.

Interpreting or determining, as utilized herein, includes receiving sensor values by any method known in the art, including at least receiving values over communication lines, from a datalink, network communication or input device, receiving an electronic signal (e.g. a voltage, frequency, current, or pulse-width-modulation signal) indicative of the value, such as the current and expected loads of a vehicle as well as user's preference or whether the rear axles are approaching or reaching their performance limit, for example, as further explained herein, receiving a computer generated parameter indicative of the value, reading the value from a memory location on a non-transient machine readable storage medium, receiving the value as a run-time parameter by any means known in the art, and/or by receiving a value by which the interpreted parameter can be calculated, and/or by referencing a default value that is interpreted to be the parameter value.

The above-described embodiments of the technology described herein can be implemented in any of numerous ways. For example, the embodiments may be implemented using hardware, software or a combination thereof. When implemented in software, the software code (or software algorithm) can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of several forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone or any other suitable portable or fixed electronic device.

Also, a computing device may have one or more input and output devices. These devices can be used, among other things, to present the user interface 710 (which may be an output device as well as an input device). Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Such computing devices may be interconnected by one or more networks in any suitable form, including as a local area network, a controller area network, or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of several suitable programming languages and/or programming or scripting tools, and also may be compiled as executable machine language code or intermediate code that is executed on a framework or virtual machine.

In this respect, the disclosed embodiments may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the disclosure discussed herein. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of the disclosure, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

As discussed above, principles of the present disclosure provide advancement in the field of electrified vehicle technology. Powertrains incorporating these principles will provide improved safety in high-voltage systems. Controls, software, and/or hardware malfunctions can occur and being the HVDC power, it is important to ensure electrical isolation form the chassis. Electrified vehicles, such as electric cars, use high-voltage electrical systems to power the vehicle. These high voltage systems pose a risk of electric shock to the occupants of the vehicle in the event of a fault or malfunction. One potential cause of electric shock is leakage current to the chassis of the vehicle. Leakage current occurs when current flows from the high voltage system to the chassis, which is typically grounded. This current can be dangerous if it exceeds safe levels. Current electrified vehicles are limited in that they provide limited safety mechanism under these circumstances. Having safety mechanisms disclosed herein will enhance overall safety of the powertrain system.

Overcurrent protection of leakage current to a chassis of an electrified vehicle is a safety mechanism that prevents electric shocks to passengers or mechanics working on the vehicle. In an electrified vehicle, the electrical system is connected to the chassis, which acts as a ground or return path for the electrical current. However, if there is a fault in the electrical system, such as a short circuit, the current can leak to the chassis and create a dangerous situation. To prevent this, the overcurrent protection system monitors the electrical system and detects any leakage current to the chassis. If the system detects an overcurrent, it immediately shuts down the electrical circuit to prevent any further leakage. This ensures the safety of passengers and mechanics working on the vehicle by preventing electric shocks and potential electrocution. Overall, the overcurrent protection of leakage current to a chassis of an electrified vehicle is a critical safety mechanism that protects against electrical hazards.

Principles of the present disclosure provide a primary safety mechanism and a secondary safety mechanism to monitor isolation faults. Under these circumstances, the secondary system is triggered, primarily if not solely, by the detection of leakage current (e.g., to the chassis, independently of controls and/or software). With their efficient and reliable power delivery, advanced safety features, and ease of use, these systems are integrable as an essential component of the electric vehicle landscape, powering the next generation of electric vehicles and helping to reduce dependence on fossil fuels. In view of the forthcoming discussion hereinbelow, using principles of the present disclosure, it will be appreciated that robust electrical isolation safety is achievable even in the case of control and/or software malfunction and/or contactor hardware failure.

The present disclosure relates to overcurrent protection of leakage current to a chassis of an electrified vehicle. More particularly, the present disclosure relates to a system and method for detecting and protecting against overcurrent leakage to the chassis of an electrified vehicle. The present disclosure provides a system and method for detecting and protecting against overcurrent leakage to the chassis of an electrified vehicle. The system includes a current sensor for detecting current flowing from the high voltage system to the chassis. If the current exceeds a predetermined threshold, the system activates a protection circuit to disconnect the high voltage system from the chassis. The protection circuit may include a switch or a relay that opens the circuit to prevent further current flow.

As used herein, the terms “path,” “circuit,” or similar terminology may be used interchangeably to describe an electrical connection or arrangement of components configured to conduct current between two or more points. For example, a “primary path” may also be referred to as a “primary circuit,” and a “secondary path” may also be referred to as a “secondary circuit,” without any intended difference in meaning. Such terms encompass conductive arrangements that may include active devices (e.g., switches, contactors, relays, reed elements), passive devices (e.g., resistors, inductors), sensors, or combinations thereof, and may extend through one or more housings, modules, or subsystems. Unless expressly stated otherwise, references to opening or closing a “path.” “circuit.” or similar are to be understood as including the corresponding interruption or completion of the electrical connection in any such arrangement.

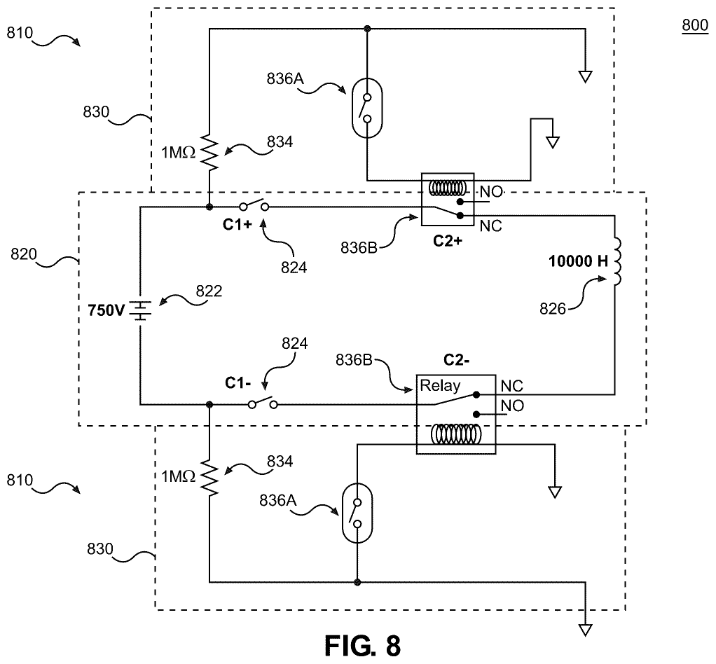

FIG. 8 shows a battery circuit 800 with an electrical isolation safety system 810 according to principles of the present disclosure. In particular, illustrated here is a 750V battery circuit with such a system that includes a primary path 820 and numerous secondary paths 830. The primary path 820 includes the battery 822 (e.g., batteries, battery packs and the like), primary contactors 824, and an inductor 826. The purpose of primary contactors 824 and an inductor 826 in an electric vehicle electrical isolation safety system is to ensure that the high voltage battery pack is safely disconnected from the rest of the vehicle in case of an emergency or maintenance. The primary contactors 824 act as switches that isolate the battery pack from the rest of the vehicle's electrical system, and the inductor 826 is used to limit the current that flows through the contactors 824 when they are opened. The inductor 826 works by storing electrical energy in a magnetic field. When an electrical current flows through the inductor 826, the magnetic field around it expands and contracts, which in turn creates a voltage that opposes the flow of the current. This opposing voltage helps to regulate the flow of electricity and prevent any sudden surges or spikes that could be dangerous to the vehicle or its passengers.

In an electric vehicle, the inductor 826 is used to provide isolation between the high voltage system and the low voltage system. This is important for safety reasons, as it helps to prevent any electrical faults or malfunctions from affecting the rest of the vehicle's systems. By using an inductor 826 in this way, the electric vehicle can operate safely and reliably, without the risk of electrical interference or damage.

When an emergency occurs or maintenance is required, the primary contactors 824 are opened to disconnect the battery pack 822. However, the sudden interruption of current flow can cause a high voltage spike that can damage the contactors 824 and other electrical components. The inductor 826 is used to limit this spike by slowing down the rate of change in current flow, thereby protecting the contactors 824 and other components. This system ensures the safety of the vehicle's occupants and maintenance personnel by preventing accidental electric shocks or fires.

The secondary paths 830 are connected to the primary path 820 and include secondary contactors 836 and resistors 834. The secondary contactors 836 and resistors 834 are designed to provide electrical isolation and reduce the energy stored in the battery circuit 822 in the event of a fault. The secondary contactors 836 are designed to connect or disconnect the secondary paths 830 to the primary path 820. The resistors 834 are connected in series with the secondary contactors 836 and are designed to limit the current in the secondary paths 830. The secondary paths 830 provide an alternative path for the energy stored in the circuit in the event of a fault. The secondary paths 830 also provide electrical isolation between the battery 822 and the load, reducing the risk of electrical shock or damage to the load.

More particularly, as illustrated, each of the secondary paths 830 includes a relatively large resistor 834 and a reed switch 836A and/or a reed relay 836B. In general, functionality of the system is such that a high resistance (˜1.2 Mohms, considering 750V battery pack) connected between both a terminal of the battery 822 (e.g., either the positive or negative terminals of the battery) and chassis ground. Optionally, a similar arrangement can be implemented on the other of the positive and negative terminals of the battery. Any fault that occurs on the positive side of the circuit or the negative side of the circuit will impact the current flowing through that (e.g., will increase it). Further connected to the circuit at the secondary path 830 is a reed switch 836A. which can be an electromechanical switch. This reed switch 836A can have a default configuration where it acts as an open switch that is further connected to a normally closed switch or relay as shown at the negative terminal side of the battery circuit. In operation, when the leakage current increases, reed switch 836A will get closed. Under these circumstances, the secondary path 830 will allow current to flow through it. The normally closed switch or relay that is connected in the main high voltage path can get energized to go to an open state.

Notably, the secondary path 830 operates independently of the primary path 820. For instance, the primary path 820 can be electronically controlled by a controls system (e.g., ECU, SCU, or the like). On the other hand, the secondary path 830 can be mechanically responsive to current and/or nearby magnetic fields. This redundancy provides additional points of failure such that the system can be in a safe condition despite one or more malfunctions of its elements. These malfunctions can be categorized as Scenarios with associated performance of primary contactors 824 and the secondary path 830, the combination of which results in a system condition that is safe or not.

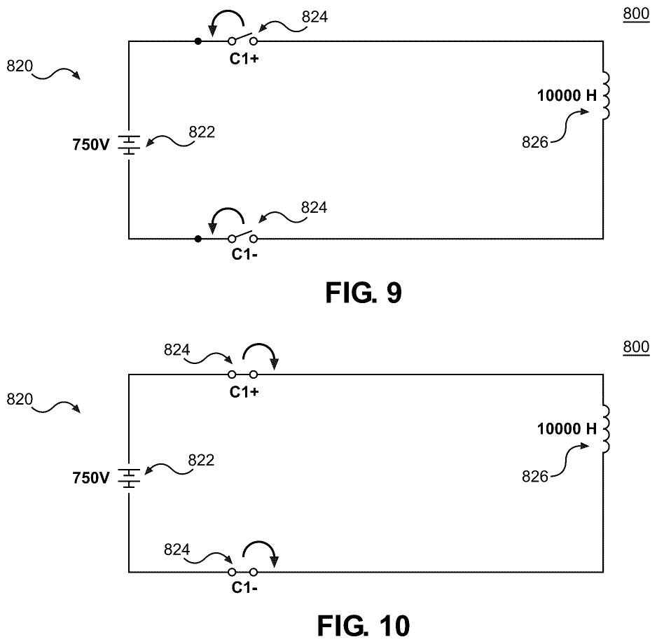

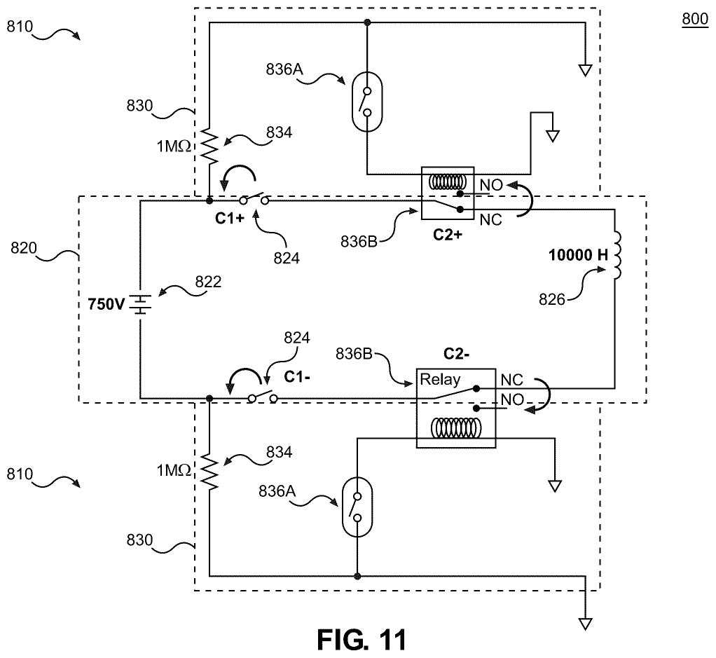

Below is a table summarizing a several detectable scenarios or fault modes for various of an electrified vehicle employing various configurations of electrical isolation safety systems based on variations or scenarios of the circuit shown in FIG. 8. Each of the first two scenarios (Scenarios 1 and 2) corresponds respectively to FIGS. 9 and 10 where there is an electrical isolation safety system with only primary contactors 824 in a primary path 820. Thus, there are no results for the secondary path 830. Each of the next four scenarios (Scenarios 3-6) corresponds respectively to FIGS. 11-14 where there is an electrical isolation safety system with both a primary path and a secondary path 830 according to principles of the present disclosure. In general, it can be observed from this table that providing a secondary path 830 allows for overall safe system operation in three of four scenarios (as compared to one of two scenarios between Scenarios 1 and 2). All these scenarios will be explained in more detail below.

TABLE 1
Summary of System Conditions Under Various Scenarios

| | | Primary | | | | | | |
|---|---|---|---|---|---|---|---|---|
| | | Contactors | | | Secondary path | | | |
| | | (C1+/C1−) | | | (C2+/C2−) | | | System |
| Scenarios | Paths | Expected | Actual | Result | Expected | Actual | Result | Condition |
| 1. Only C1 | C1+/C1− Only | C1 Open | C1 Open | Success | Not Applicable | | | Safe |
| present | | | | | | | | |
| 2. Only C1 | | C1 Open | C1 Closed | Failed | | | | Safety |
| present | | | | | | | | Concern |
| 3. Normal | C1+/C1− & | C1 Open | C1 Open | Success | C2 Open | C2 Open | Success | Safe |
| Condition | C2+/C2− | | | | | | | |
| 4. C1 | | C1 Open | C1 Closed | Failed | C2 Open | C2 Open | Success | Safe |
| Malfunction | | | | | | | | |
| 5. C2 | | C1 Open | C1 Open | Success | C2 Open | C2 Closed | Failed | Safe |
| Malfunction | | | | | | | | |
| 6. C1 & C2 | | C1 Open | C1 Closed | Failed | C2 Open | C2 Open | Failed | Probability |
| Malfunction | | | | | | | | is very low |

In the following discussion, note that use of “C1” can refer to either or both of C1+ and C1− and “C2” can refer to either or both of C2+ and C2−. Thus, interpreting either C1 or C2 otherwise is inconsistent with the scope of this disclosure. Further, referring singularly to either C1+ and C1− or either C2+ and C2− should not preclude substitution for the other unless otherwise stated.

For discussion purposes, FIGS. 9 and 10 show circuits with only primary paths—i.e., with the secondary path 830 illustratively removed. In particular, FIG. 9 illustrates a scenario where C1 us opened as expected, resulting in a system success and safe operation condition. On the other hand, FIG. 10 illustrates a scenario where C1 is unexpectedly closed, resulting in a system success and safe operation condition. Comparing these two scenarios, which together account for all possible scenarios when only a primary path is provided, there is only a 50% probability of safety in such a system.

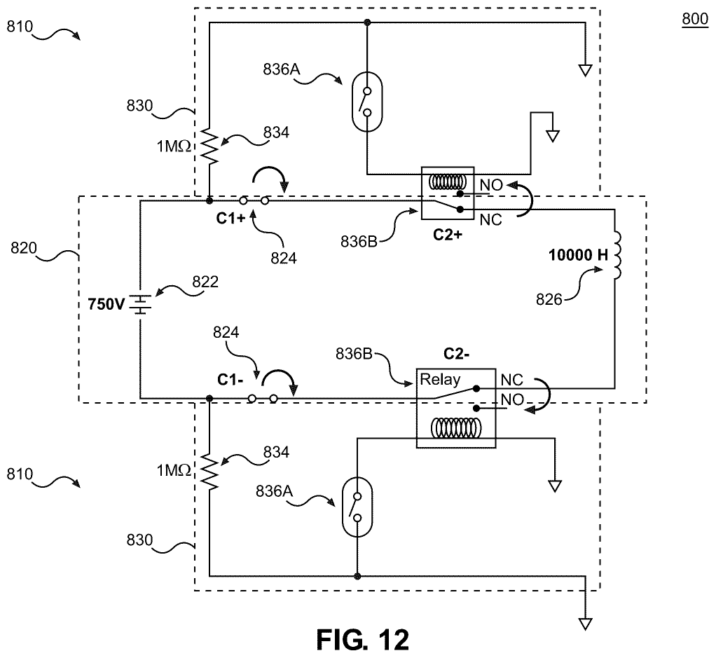

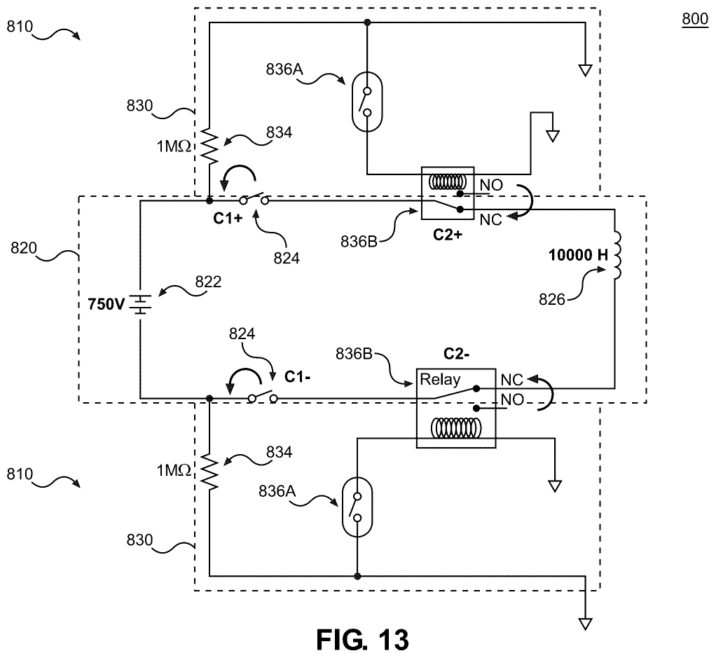

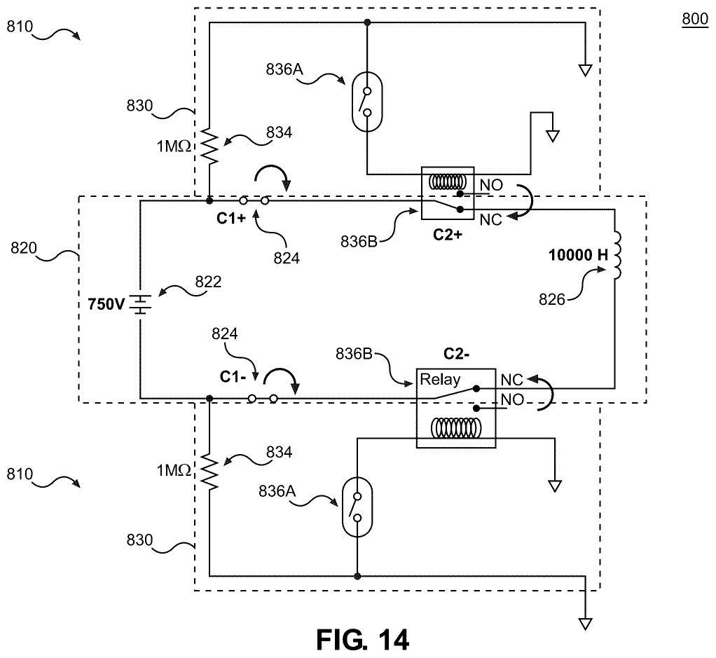

Now compare this result to one with that of a system where the secondary path 830 is illustratively reintroduced. FIGS. 11-14 illustrate such a system. To start, FIG. 11 shows a normal condition in which it is expected that C1 is open, and the system responds in kind. As well, it is expected that C2 is open, and the system similarly responds in kind. Under these circumstances, both C1 and C2 are operationally successful, and the system is safe overall. Turning to FIG. 12, here there is a malfunction of C1 where C1 is expected to be open but is actually closed, resulting in a failure of only C1. But advantageously, C2 is expected to be open and is actually open, resulting in a success of C2 and overall safe system. Next, FIG. 13 shows a system where there is a malfunction of C2 where C2 is expected to be open but is actually closed, resulting in a failure of only C2. But advantageously, C1 is expected to be and is actually open, resulting in a success of C1 and overall safe system. Last, FIG. 14 shows a system where there is a malfunction of both C1 and C2, where both C1 and C2 are expected to be open but are actually closed. As a result, the system has a failure of both C1 and C2 and has an overall unsafe condition. Comparing these four scenarios, which together account for all possible scenarios when there are primary and secondary paths 820, 830 provided, there is an improved 75% probability of safety in such a system.

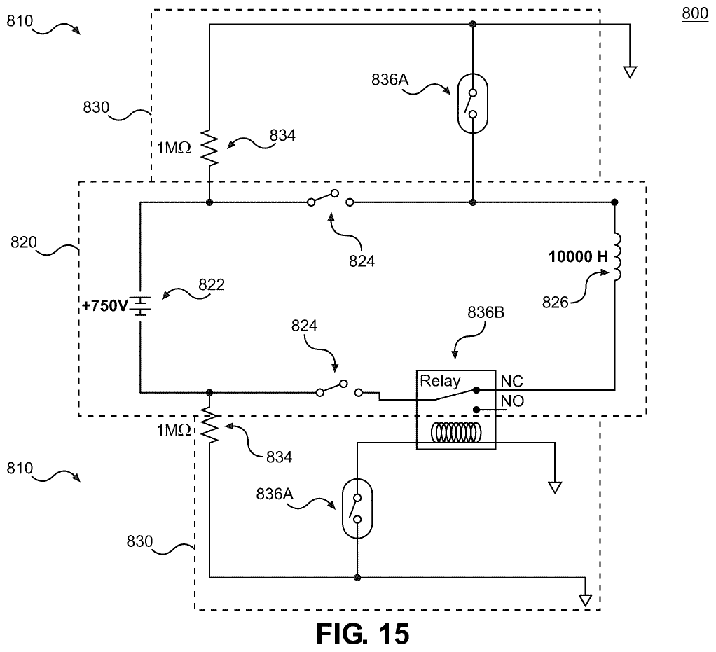

Not all battery circuits disclosed herein require two reed relays 836B. To illustrate this principle, FIG. 15 shows a schematic of a battery circuit with an electrical isolation safety system having primary and secondary paths 820, 830 as discussed previously herein in relation to FIGS. 8-14. But here, one of the secondary paths 830 is fitted with a reed switch 836A instead of a reed relay 836B. Reed relays 836B and reed switches 836A are both compact, reliable, and easy-to-use switches that are mechanically actuated to open and close a path. Reed relays 836B are a type of relay that use magnetic reeds for switching, while reed switches 836A operate using the potential difference of a magnetic field. Thus, a system with both reed switches 836A and relays 836B can have different triggers for opening and closing depending on when leakage current occurs. Increasing the number of triggers can make for a more robust system. For instance, an issue that can occur with reed relays 836B is that there is magnetic coupling from the coil. Each reed relay 836B assembly will have an associated magnetic field that extends beyond the mechanical confines of the relay itself. If the magnetic field is not contained, then the field from an adjacent relay or relays can oppose the field within the relay in question. So, for example, in ultra compact installations, a combination of a reed switch 836A and reed relay 836B in the secondary paths 830 or a singular one of each of the secondary paths 830 may be desirable.

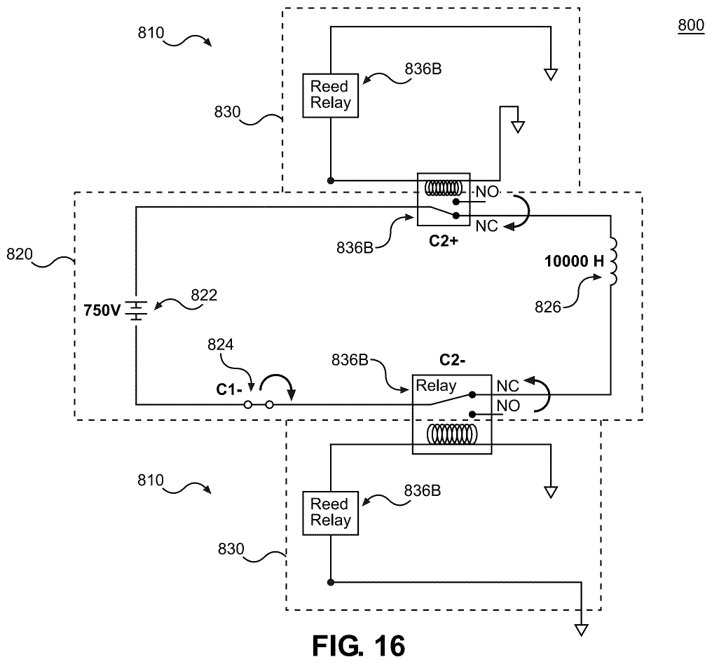

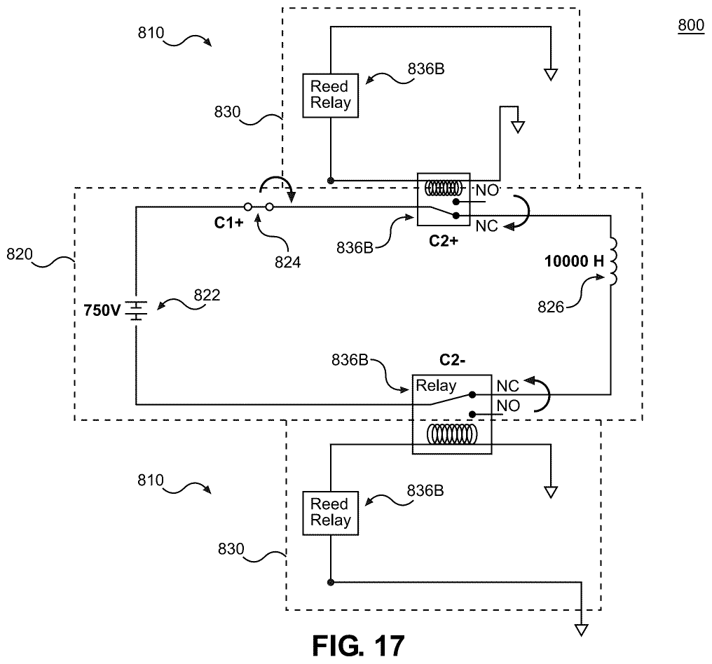

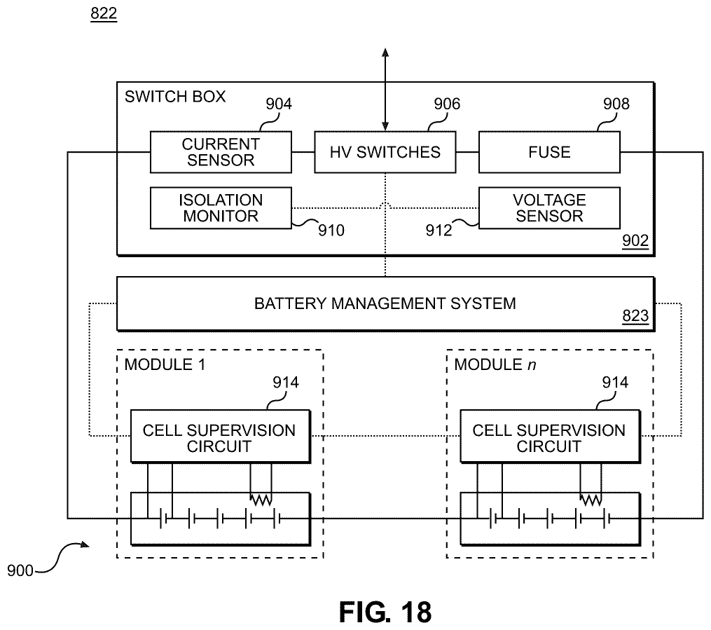

Notably, positive and negative primary contactors 824 are included in the primary path 820 to provide robust safety system. But examples of the present disclosure need not always include both primary contactors 824 and may have other alterations to the secondary path 830. FIGS. 16 and 17 show an example of such systems. In particular, FIG. 16 shows a schematic of a battery circuit with an electrical isolation safety system having primary and secondary paths 820. 830 as discussed previously herein in relation to FIGS. 8-14. But here, there is only a singular primary contactor 824 at a negative side of the battery. As well, in the secondary paths 830 includes a relay 836B in the primary path 820 and a reed relay 836B connected to ground. On the other hand, FIG. 17 shows a schematic of a battery circuit with an electrical isolation safety system having primary and secondary paths 820, 830 as discussed previously herein in relation to FIGS. 8-14. But here, in contrast to FIG. 18, there is only a singular primary contactor 824 at a positive side of the battery. As well, in the secondary paths 830 includes a relay 836B in the primary path 820 and a reed relay 836B connected to ground. These are just some examples of the many examples disclosed elsewhere herein.

Indeed, as elements along the secondary path 830 together provide an additional safety layer, there is an opportunity to have less contactors in the entire circuit. As an example, while previously discussed implementations included C2+ (controls independent) for C1+ (controls dependent) and C2-(controls independent) for C1− (controls dependent), other implementations include a single primary contactor C1+ or C1−. In some implementations, C1+ is preferred as the primary contactor and C2+, C2− as an isolation monitoring system. As noted above, such a hardwired isolation monitoring system for an electric vehicle is a safety feature that ensures that the electrical system of the vehicle is isolated from the ground. The system works by continuously monitoring the electrical insulation between the vehicle's high-voltage components and the ground. If the insulation is compromised, the system will immediately detect the fault and isolate the high-voltage components from the rest of the vehicle's electrical system.

FIG. 18 shows a schematic illustration of an electrical vehicle battery pack 822 according to principles of the present disclosure. As illustrated, the schematic includes a switch box 902 having a current sensor 904, high voltage (HV) switches 906, fuses 908, isolation monitors 910, and a voltage sensor 912; a battery management system (BMS) 823 having multiple modules with cell supervision circuits 914; and an electrical isolation failure safety system 900.

Several electrical elements are housed in the switch box 902. The switch box 902 is designed to integrate multiple functionalities within a single housing. The current sensor 904, high voltage switches 906, fuses 908, isolation monitors 910, and voltage sensor 912 work in concert to manage and monitor the electrical characteristics of the battery pack. The high voltage switches 906 are robust components capable of handling the power levels typical in EV applications, allowing for reliable operation under high voltage conditions. The current sensor 904 is positioned to measure the electrical current flowing through the battery pack. This sensor is capable of providing real-time data on the current, which is useful for performance monitoring and management. The high voltage switches 906 control an electrical connection between the battery pack and the vehicle's powertrain. They are designed to handle high voltages and enable safe disconnection of the battery pack when necessary. Integrated into the switch box 902, fuses 908 are protective devices that prevent excessive current from causing damage to the electrical circuits. They are placed in series with the battery connections to protect the system from overcurrent conditions. Isolation monitors 910 continuously or intermittently assess an insulation resistance between the high voltage circuits of the battery pack and the vehicle chassis. They are useful for detecting insulation degradation and preventing potential electrical hazards. Voltage sensor 912 measures the voltage of the battery pack and provides this data to the BMS. Accurate voltage measurement is useful for determining the SOC and ensuring proper battery management.

Battery management system 823 is a sophisticated system responsible for monitoring and managing the battery cells. The BMS 823 can be a modular system composed of multiple interconnected modules as indicated by “Module n,” each equipped with cell supervision circuits 914. These circuits perform continuous monitoring and data collection on individual cells. The BMS 823 processes this data to balance cell charge, prevent overcharging or deep discharging, and manage thermal conditions to ensure the overall health and performance of the battery pack. Located within one or multiple modules of the BMS 823, cell supervision circuits 914 monitor individual cells in the battery pack. They measure parameters such as cell voltage, temperature, and SOC. This monitoring ensures that each cell operates within safe limits, balances cell performance, and enhances the battery pack's overall efficiency and lifespan. The BMS 823 can be modular in design, with each module responsible for supervising a subset of cells. This distributed approach allows for precise and scalable management of the entire battery pack.

Electrical isolation failure safety system 900 is a safety feature designed to detect and respond to electrical isolation failures. This system 900 is designed to address potential risks associated with electrical isolation failures. The isolation monitors 910 provide continuous feedback on insulation integrity, while the safety response mechanisms automatically isolate the battery pack from the vehicle's electrical system in the event of a detected fault. The alerting and reporting features ensure that both the vehicle's control system and the driver are informed of any critical issues, enabling prompt action to mitigate risks. Isolation fault detection components detect any failure in the insulation that separates high voltage circuits from the vehicle chassis. It ensures that any issues with insulation are promptly identified. As safety response mechanisms in response to detected isolation faults, the system activates safety measures such as disconnecting the battery pack from the vehicle's electrical system to prevent potential hazards and ensure safety. For alerting and reporting, the system provides notifications to the vehicle's control system and, where applicable, to the driver. This ensures that any issues are addressed quickly and effectively.

The described schematic offers several advantages. For instance, advantages include enhanced safety because the combination of isolation monitors 910, high voltage switches 906, and electrical isolation failure safety systems 900 ensures robust protection against electrical hazards. Advantages include improved battery management where the BMS with cell supervision circuits 914 provides precise and effective management of individual cells, enhancing battery performance and lifespan. Advantages yet include real-time monitoring where current and voltage sensors 912 enable real-time monitoring of the battery pack's operational parameters, facilitating timely responses to changing conditions.

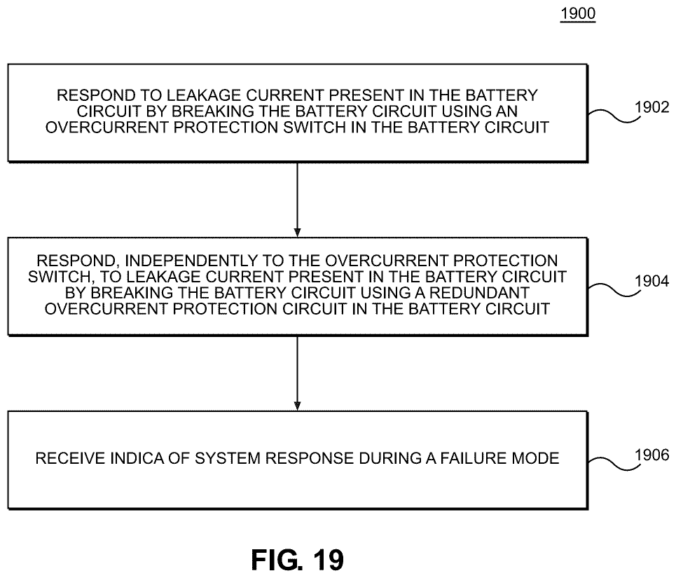

FIG. 19 is a flowchart of a method 1900, according to an example of the present disclosure. According to an example, one or more method blocks of FIG. 19 may be performed by electrical isolation system.

As shown in FIG. 19, method 1900 may include responding to leakage current present in the battery circuit by breaking the battery circuit using an overcurrent protection switch in the battery circuit (block 1902). For example, system may respond to leakage current present in the battery circuit by breaking the battery circuit using an overcurrent protection switch in the battery circuit, as described above. As also shown in FIG. 19, method 1900 may include responding, independently to the overcurrent protection switch, to leakage current present in the battery circuit by breaking the battery circuit using a redundant overcurrent protection circuit in the battery circuit such that the redundant overcurrent protection circuit is more responsive in one or more fault modes of the electrified vehicle than is the overcurrent protection switch alone (block 1904). For example, device may respond, independently to the overcurrent protection switch, to leakage current present in the battery circuit by breaking the battery circuit using a redundant overcurrent protection circuit in the battery circuit such that the redundant overcurrent protection circuit is more responsive in one or more fault modes of the electrified vehicle than is the overcurrent protection switch alone, as described above.

Method 1900 may include additional implementations, such as any single implementation or any combination of implementations described below and/or in connection with one or more other methods described elsewhere herein. In a first implementation, the one or more fault modes in which the redundant overcurrent protection circuit is more responsive than is the overcurrent protection switch alone includes failure of the overcurrent protection switch. In a second implementation, alone or in combination with the first implementation, responding to leakage current present in the battery circuit by breaking the battery circuit using the overcurrent protection switch includes receiving an indication to open the overcurrent protection switch in response to detecting a leakage current by a battery management system 823 of the electrified vehicle. In examples, the system can receive some indicia of how the system responded to the leakage current (e.g., which switches, if any, were operable during a failure mode or leakage current event) (block 1906).

It should be noted that while FIG. 19 shows example blocks of method 1900, in some implementations, method 1900 may include additional blocks, fewer blocks, different blocks, or differently arranged blocks than those depicted in FIG. 19. Additionally, or alternatively, two or more of the blocks of method 1900 may be performed in parallel.

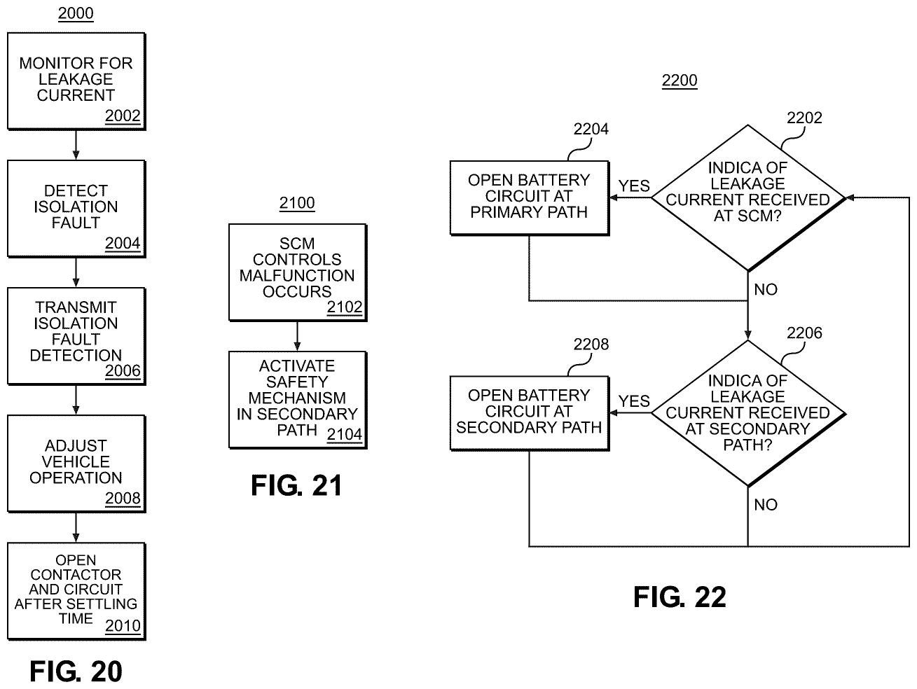

FIGS. 20-22 outline several additional methods disclosed herein. Particularly, FIG. 20 is a flowchart showing electrical isolation failure safety mechanism for a battery electric vehicle or a fuel cell electric vehicle. FIG. 21 is a flowchart showing a failure mode of an electrified vehicle when isolation monitoring is lost. And FIG. 22 is a flowchart showing a functioning mechanical feature of a secondary safety layer for an isolation fault. Many of the steps in each flow chart can be connected or combined as will be evident to those skilled in the art.

Referring to FIG. 20, a method 2000 of electrical isolation failure safety for an electrified vehicle is shown. The method 2000 begins by having a system control module (SMC) monitor a low voltage line that runs across high voltage loop (block 2002). In case of a leakage current to the chassis, SCM detects the isolation fault (block 2004) and sends a signal to the dashboard (block 2006), and vehicle goes in limp home mode (block 2008). After consideration of settling time for the vehicle (block 2010), SCM opens the contactor and opens the circuit.

Referring to FIG. 21, a method 2100 of operating an electrified vehicle in a failure mode is shown. The method begins by assessing whether an isolation monitoring function of the electrified vehicle is lost. For instance, an SCM determines whether there is an isolation fault or leakage current (block 2102), but an SCM controls malfunction occurs. If so, chassis of the electrified vehicle will be electrified without any warning sign and contactors would still be closed. A chassis mounted safety mechanism gets activated (block 2104) to break the circuit. For instance, the circuit can include either piezoelectrical material or electric actuator or a secondary relay circuit to break the primary circuit.

Malfunctions can occur due to Controller Area Network (CAN) grounding issues, Electromagnetic Interference (EMI) issues, Electromagnetic Compatibility (EMC) issues, and/or software malfunction (e.g., reset or crash). CAN is a communication protocol used in vehicles and other industrial applications to allow different electronic systems to communicate with each other. CAN grounding issues refer to problems that arise when the ground connection for the CAN network is not properly established or maintained. When the ground connection is not functioning properly, it can cause errors in the communication between different systems, leading to malfunctions or even system failures. In that case chassis will be electrified without any warning sign and contactors would still be closed. EMI and EMC are two related concepts that deal with the effects of electromagnetic radiation on electronic devices. EMI refers to the unwanted electromagnetic signals that can interfere with the proper functioning of electronic devices, while EMC refers to the ability of electronic devices to function properly in the presence of electromagnetic radiation. In an electrified vehicle, EMI-EMC is crucial to ensure that the vehicle's electrical system operates efficiently and safely. This involves the use of shielding, filtering, and grounding techniques to minimize the impact of EMI on the vehicle's electronic components and systems. Additionally, proper design and layout of the electrical system can also help to reduce EMI-EMC issues.

FIG. 22 shows a method 2200 where a functioning mechanical feature operates as a secondary safety layer for an isolation fault, but the primary safety layer operates as intended. The method 2200 begins by receiving indicia that there is leakage current via the SCM (block 2202). This step can include monitoring a low voltage line that runs across high voltage loop. In case of a leakage current to the chassis, SCM detects the isolation fault and sends a signal to the dashboard. SCM opens the contactor and opens the circuit (block 2204). The method 2200 begins by receiving indicia that there is leakage current via one or more components at the secondary path (block 2206). Components of the secondary path then open the circuit (block 2208).

The following are practical examples of various implementations of principles of the present disclosure. These are just some examples of the many examples disclosed herein and should not be construed as limiting to the scope of the present disclosure. In fact, one skilled in the art will appreciate several variations of these examples, each of which is included in the scope of this disclosure.

As used herein, the term “control system” may refer to the overall functional architecture responsible for monitoring, managing, and controlling electrical components within the electrified vehicle. The control system may include one or more control units, sensor interfaces, processing algorithms, and communication protocols. The term “control unit” may refer to a specific physical hardware module, such as an electronic control unit (ECU), that implements part of the control system's logic. In some examples, the control system may be distributed across multiple control units that communicate over a vehicle network, such as a controller area network (CAN) bus.

In Example 1, an electrical isolation system for a high voltage battery circuit in an electrified vehicle, the electrical isolation system mounted to a chassis of the electrified vehicle and comprising: an overcurrent protection switch that is configured to be responsive to leakage current present in the high voltage battery circuit by breaking the high voltage battery circuit and a redundant overcurrent protection circuit that is configured to be responsive to leakage current present in the high voltage battery circuit in a manner that is different from the overcurrent protection switch to break the high voltage battery circuit such that the redundant overcurrent protection circuit is more responsive in one or more fault modes of the electrified vehicle than is the overcurrent protection switch alone.

In Example 2, the electrical isolation system as Example 1 describes, wherein the redundant overcurrent protection circuit includes an electromechanical switch to break the high voltage battery circuit.

In Example 3, the electrical isolation system as either of Examples 1 or 2 describe, wherein the overcurrent protection switch is controlled by a control system of the electrified vehicle.

In Example 4, the electrical isolation system as any of Examples 1-3 describe, wherein the redundant overcurrent protection circuit includes at least one reed element.

In Example 5, the electrical isolation system as any of Examples 1-4 describe, wherein the at least one reed element includes a reed relay.

In Example 6, the electrical isolation system as any of Examples 1-5 describe, wherein the reed relay is normally closed.

In Example 7, the electrical isolation system as any of Examples 1-6 describe, wherein the at least one reed element includes a first reed element and a second reed element to electrify the first reed element to break the circuit.

In Example 8, the electrical isolation system as any of Examples 1-7 describe, wherein the redundant overcurrent protection circuit further includes a resistor arranged between a terminal of the battery and the chassis.

In Example 9, the electrical isolation system as any of Examples 1-8 describe, wherein the redundant overcurrent protection circuit is a first redundant overcurrent protection circuit, wherein the electrical isolation system further comprises a second redundant overcurrent protection circuit, and wherein the high voltage battery circuit further includes an inductor arranged between the first and second redundant overcurrent protection circuits.

In Example 10, the electrical isolation system as any of Examples 1-9 describe, wherein: the first redundant overcurrent protection circuit includes a first normally closed switch that includes an input side and a power side, the input side is arranged between the inductor and a first battery terminal of the battery, and the power side is arranged between a first chassis-grounded reed element and the chassis; the overcurrent protection switch is arranged between a second battery terminal of the battery and the second redundant overcurrent protection circuit;
and the second redundant overcurrent protection circuit includes a second normally closed switch that includes an input side and a power side, the input side is arranged between the overcurrent protection switch and the inductor, and the power side is arranged between a second chassis-grounded reed element and the chassis.

In Example 11, the electrical isolation system as any of Examples 1-10 describe, wherein the first battery terminal is a positive terminal of the battery, and the second battery terminal is a negative terminal of the battery.

In Example 12, the electrical isolation system as any of Examples 1-11 describe, wherein the first and second chassis-grounded reed elements are reed relays.

In Example 13, the electrical isolation system as any of Examples 1-12 describe, further comprising a first chassis-grounded resistor arranged between the first battery terminal and a chassis ground and a second chassis-grounded resistor that is arranged between the second battery terminal and the chassis ground, wherein the first chassis-grounded reed element is a first reed switch that is connected to the first chassis-grounded resistor and the second chassis-grounded reed element is a second reed switch that is connected to a second chassis grounded resistor.

In Example 14, the electrical isolation system as any of Examples 1-13 describe, wherein the overcurrent protection switch is a first overcurrent protection switch, and wherein the electrical isolation system further includes a second overcurrent protection switch, each of the first overcurrent protection switch and the first redundant overcurrent protection circuit is arranged at a first battery terminal of the battery, and each of the second overcurrent protection switch and the second redundant overcurrent protection circuit is arranged at a second battery terminal of the battery.

In Example 15, an electrified vehicle, comprising: a high voltage battery circuit; and an electrical isolation system for the high voltage battery circuit in the electrified vehicle, the electrical isolation system mounted to a chassis of the electrified vehicle and comprising: an overcurrent protection element that is configured to be responsive to leakage current present in the high voltage battery circuit by breaking the high voltage battery circuit and first and second redundant overcurrent protection circuits that are configured to be responsive to leakage current present in the high voltage battery circuit in a manner that is different from the overcurrent protection switch to break the high voltage battery circuit such that the first and second redundant overcurrent protection circuits are more responsive in one or more fault modes of the electrified vehicle than is the overcurrent protection switch alone.

In Example 16, the electrified vehicle as Example 15 describes, wherein the first redundant overcurrent protection circuit is arranged at a first battery terminal of the battery, and the second redundant overcurrent protection circuit is arranged at a second battery terminal of the battery.

In Example 17, the electrified vehicle as either of Examples 15 or 16 describe, wherein the overcurrent protection element is a first overcurrent protection switch, and wherein the electrical isolation system further includes a second overcurrent protection switch, each of the first overcurrent protection switch and the first redundant overcurrent protection circuit is arranged at a first battery terminal of the battery, and each of the second overcurrent protection switch and the second redundant overcurrent protection circuit is arranged at a second battery terminal of the battery.

In Example 18, a method of mitigating loss of isolation in a battery circuit of a high-voltage system in an electrified vehicle, the method comprising: responding to leakage current present in the battery circuit by breaking the battery circuit using an overcurrent protection switch in the battery circuit, and responding, independently to the overcurrent protection switch, to leakage current present in the battery circuit by breaking the battery circuit using a redundant overcurrent protection circuit in the battery circuit such that the redundant overcurrent protection circuit is more responsive in one or more fault modes of the electrified vehicle than is the overcurrent protection switch alone.

In Example 19, the method as Example 18 describes, wherein the one or more fault modes in which the redundant overcurrent protection circuit is more responsive than is the overcurrent protection switch alone includes failure of the overcurrent protection switch.

In Example 20, the method as either of Examples 18 or 19 describe, wherein responding to leakage current present in the battery circuit by breaking the battery circuit using the overcurrent protection switch includes receiving an indication to open the overcurrent protection switch in response to detecting a leakage current by a battery management system of the electrified vehicle.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

### Practical Example Scenarios Across Platforms

The following description provides representative, non-limiting examples of how the claimed electrical isolation system may be implemented and operated in different vehicle architectures and energy storage configurations. These examples are provided to illustrate the versatility and adaptability of the disclosed principles and are not intended to limit the scope of the present disclosure. Variations, modifications, and substitutions will be apparent to those skilled in the art in light of the teachings herein, and the system may be employed in whole or in part across a wide range of high-voltage applications beyond the specific instances described below.

In various embodiments, the claimed electrical isolation system may be implemented across a broad range of electrified mobility and stationary energy storage platforms, each benefitting from the multi-layered protection afforded by the combination of a primary safety layer (C1) and a secondary safety layer (C2). The primary safety layer may be a control-dependent overcurrent protection switch, such as a high-voltage contactor, arranged in the main battery circuit and commanded open by a battery management system (BMS) or vehicle control unit upon detection of an isolation fault. The secondary safety layer may be a control-independent overcurrent protection circuit triggered solely by leakage current to chassis ground. This redundant path includes a high-resistance element-typically about 1.0 to 1.2 MΩ for a 750 V pack-coupled with a reed switch or reed relay that changes state upon energization from the leakage current, in turn actuating a normally closed high-voltage relay in the main circuit to open and isolate the pack.

The safety benefits of this dual-path architecture are evident when comparing functional scenarios, as illustrated by FIGS. 9-14. In a primary-only system, a normal operating event in which C1 opens as expected results in a safe condition; however, if C1 fails to open due to welded contacts or a control malfunction, the vehicle remains unsafe. Adding the secondary path increases the likelihood of a safe system outcome to approximately 75% of possible failure scenarios, since C2 will operate independently of the control system to open the circuit whenever leakage current is present, even if C1 remains closed. This architecture is also tolerant to certain C2 faults, since C1 can still provide isolation if C2 fails to open. The rare condition in which both C1 and C2 are welded closed presents an unsafe condition, but with low statistical probability given independent failure modes.

Because the C2 circuit is physically and electrically isolated from vehicle control wiring, it is immune to failures arising from Controller Area Network (CAN) grounding issues, electromagnetic interference (EMI), electromagnetic compatibility (EMC) disturbances, and control software resets or crashes. This characteristic makes the system particularly valuable in platform types where EMI is prevalent or where redundancy is mandated by safety standards. For example, in a battery electric passenger vehicle (BEV) with 400 V or 800 V architecture, C2 can be integrated within the battery pack's junction box on both positive and negative terminals, providing redundant isolation during routine driving or charging. In fuel cell electric vehicles (FCEV), such as Class 8 long-haul trucks, C2 ensures safe isolation even during the unique transient conditions of fuel cell stack start-up or shutdown when the primary isolation monitor may be temporarily disabled. In plug-in hybrid electric vehicles (PHEV), C2 can protect the HV battery during engine-assist modes when insulation monitoring intervals are extended or control-based isolation is deferred.

For heavy-duty battery electric buses using a 750 V nominal pack in a dual- or tri-axle configuration (FIGS. 1 and 4), C2 relays can be distributed at strategic points in the series-connected modules so that a single leakage current anywhere in the pack will actuate the redundant isolation. In off-highway electrified machinery, such as mining haul trucks operating in harsh EMI-rich environments, the control independence of C2 mitigates the risk of loss of isolation monitoring from EMI-EMC disruption, providing a purely hardware-based failsafe. The system is also adaptable to stationary energy storage systems (ESS), such as grid-tied 1 MWh battery cabinets, where it can function in parallel with SCADA-controlled isolation to protect against network or software failures.

In each of these platforms, the operational sequence is similar. Under normal conditions, both C1 and C2 remain closed and leakage current is below the trip threshold. If leakage current is detected, the control system commands C1 open; if C1 operates correctly, the circuit is isolated. If C1 fails, the leakage current energizes the reed element in C2, opening its normally closed relay and breaking the circuit independently of the control system. Once the fault is cleared, C2 returns to the closed position automatically without requiring manual reset. This repeatable, low-cost, and control-independent protection strategy provides robust electrical isolation safety across diverse mobility and stationary applications, even in the presence of control, software, or primary hardware failures.

### GUIDANCE

The following section provides interpretive guidance for understanding and applying the principles described in this disclosure. It outlines key concepts related to embodiment flexibility, parameter variation, structural adaptability, and claim interpretation for electrical isolation systems and methods for a high voltage battery circuit in an electrified vehicle. While this section sets forth representative principles by which one skilled in the art may interpret the scope and implementation of the disclosed systems, it is not exhaustive and should not be construed as limiting. Instead, it serves to ensure clear, adaptable, and contextually accurate understanding of the embodiments described herein, including their potential equivalents and extensions under applicable patent law.

The description provided is intended to accompany and clarify the figures and flow diagrams included in this disclosure, with the goal of instructing one skilled in the art in representative implementations of overcurrent protection, materials, estimation methods, and control strategies. Where terms such as “is,” “are,” or similar definitive language are used to describe elements in the figures, such usage should not be interpreted as limiting or exclusive. Instead, such terms reflect how features may be implemented or depicted in example embodiments. As will be apparent to those skilled in the art, the described configurations are illustrative only and do not preclude alternative structures, materials, or arrangements that accomplish comparable functions. The figures and description are thus to be understood as non-limiting examples among many possible implementations consistent with the broader principles disclosed herein.

Although the systems, methods, and materials described herein are tailored primarily for electrical isolation systems and methods for the safe and reliable operation of electrified vehicles, the disclosed principles and structures may also be applied to other high voltage battery applications, energy storage formats, and power system configurations, including but not limited to blended cathode materials, hybrid battery modules, and advanced battery management systems (BMS). The structures and functionalities described are suitable for any application involving high voltage batteries where overcurrent protection with high accuracy and fast response times are required.

The embodiments and examples presented in the detailed description are intended to be illustrative and not exhaustive. Specific configurations are described for clarity, but they represent only a subset of possible implementations that may be developed based on the disclosure herein. Features of one embodiment may be combined with features of another, whether or not such combinations are explicitly described. Similarly, individual features may be omitted from certain implementations without departing from the scope of the claims. All such variations, substitutions, and adaptations apparent to a person of ordinary skill in the art are considered within the scope of this disclosure and its claims.

For clarity and to focus on key inventive aspects, certain supporting features commonly present in battery systems-such as recalibration procedures, asynchronous time steps, impedance analysis routines, additional physical signals to measure, or other safeguards—may be simplified or omitted in the figures and description. Their design and integration are well understood by skilled practitioners and do not need to be shown in exhaustive detail to convey the core principles of the present disclosure. Detailed specifications of such ancillary components may be provided in production engineering documentation as appropriate.

Ranges provided in this disclosure should be interpreted to include both their stated endpoints and any intermediate values, unless explicitly indicated otherwise. Unless otherwise stated, a range or single value should be understood to include values that one of ordinary skill in the art would deem generally equivalent or sufficiently close for the intended function, including values that vary by plus or minus a reasonable percentage appropriate for the technical field. Phrases such as “generally within a range,” “approximately,” “about.” “substantially.” “roughly,” “sufficiently,” or similar qualifiers, when used with ranges or values, are intended to allow for practical engineering and manufacturing tolerances, measurement uncertainty, and performance margins without limiting the claims to absolute numerical boundaries. Where a single value or limit is disclosed without an explicit range, it should be interpreted as encompassing that value and all functionally equivalent values within such reasonable variation, consistent with the doctrine of equivalents.

Use of modifiers such as “approximately.” “generally,” “substantially,” “sufficiently,” and similar terms is intended to capture acceptable variation that does not materially affect the intended operation or performance of the described system. These terms do not narrow the scope of the claims to exact figures unless expressly stated otherwise.

Use of “or” in lists should be understood as inclusive unless the context clearly indicates otherwise, meaning that any one, any combination, or all listed elements may be encompassed. Phrases such as “at least one of A, B, and C” should be interpreted to mean any of A, B, or C individually, any combination thereof, or all of them together. The term “a portion” may refer to part or all of a given element, unless clearly indicated otherwise.

Terms such as “coupled,” “connected,” or “joined” encompass both direct and indirect relationships between elements, including mechanical, electrical, thermal, or fluidic connections, whether fixed, flexible, integrated, or modular. For example, components described as “thermally coupled” or “electrically connected” include arrangements with or without intervening interfaces, conductive paths, or insulating structures.

Where steps in a method are presented in a specific order, that order should not be construed as required unless explicitly stated. Method steps may be performed in different sequences, in parallel, combined, or omitted, depending on the desired implementation. Descriptions of method operations are provided for illustrative guidance and do not limit procedural flexibility except where explicitly recited in the claims.

The structures, materials, methods, and configurations described herein are intended to illustrate, not limit, the scope of the invention. All modifications, substitutions, equivalents, and functional alternatives that achieve the described objectives using different arrangements—whether now known or later developed—are intended to fall within the scope of the appended claims and are protected under applicable doctrines of patent law, including the doctrine of equivalents.

What is claimed is:

1. An electrical isolation system for a high voltage battery circuit in an electrified vehicle, the electrical isolation system mounted to a chassis of the electrified vehicle and comprising:
an overcurrent protection switch that is configured to be responsive to leakage current present in the high voltage battery circuit by breaking the high voltage battery circuit and to be actuated by a control system of the electrified vehicle in response to the detection of leakage current, the actuation causing the overcurrent protection switch to interrupt current flow through the high voltage battery circuit; and
a redundant overcurrent protection circuit that is configured to be (i) responsive to leakage current present in the high voltage battery circuit in a manner that is different from the overcurrent protection switch to break the high voltage battery circuit, (ii) activated independently of the control system and includes at least one electromechanical component that physically breaks the high voltage battery circuit based on passive detection of fault current, and (iii) triggerable in one or more fault modes in which the overcurrent protection switch fails to respond, such that the redundant overcurrent protection circuit is more responsive in one or more fault modes of the electrified vehicle than is the overcurrent protection switch alone,
wherein the system is included in a control unit of the electric vehicle.

2. The electrical isolation system of claim 1, wherein the redundant overcurrent protection circuit includes an electromechanical switch configured to transition to an open state in response to current flow above a predefined threshold caused by a loss of electrical isolation, thereby physically disconnecting the high voltage battery circuit and interrupting current flow to mitigate hazards, and wherein the redundant overcurrent protection circuit is triggerable in one or more fault modes in which the overcurrent protection switch fails to respond, including at least one of failure of a control system, a software malfunction, and an actuator failure.

3. The electrical isolation system of claim 2, wherein the overcurrent protection switch is controlled by a control system of the electrified vehicle, wherein the control system evaluates leakage current parameters received from isolation monitoring sensors and issues a command signal to open the overcurrent protection switch when a safety threshold is exceeded.

4. The electrical isolation system of claim 2, wherein the redundant overcurrent protection circuit includes at least one reed element, the reed element being magnetically responsive to leakage current-induced fields to provide a passive trigger mechanism independent of vehicle software.

5. The electrical isolation system of claim 4, wherein the at least one reed element includes a reed relay, wherein the reed relay actuates upon detecting a magnetic field associated with current leakage to the chassis, thereby enabling mechanical disconnection of the high voltage battery circuit.

6. The electrical isolation system of claim 5, wherein the reed relay is normally closed, such that the circuit remains connected under normal operation and automatically transitions to an open state when magnetic actuation occurs due to excessive leakage current.

7. The electrical isolation system of claim 5, wherein the at least one reed element includes a first reed element and a second reed element to electrify the first reed element to break the circuit, wherein the second reed element generates a magnetic field upon detecting leakage current and the first reed element receives the command signal to mechanically interrupt current flow.

8. The electrical isolation system of claim 5, wherein the redundant overcurrent protection circuit further includes a resistor arranged between a terminal of a battery and the chassis, wherein the resistor establishes a high-resistance fault detection path to enable a small current to flow in the event of insulation failure, thereby enabling the reed relay to sense the fault.

9. The electrical isolation system of claim 1, wherein the redundant overcurrent protection circuit is a first redundant overcurrent protection circuit, wherein the electrical isolation system further comprises a second redundant overcurrent protection circuit, and wherein the high voltage battery circuit further includes an inductor arranged between the first and second redundant overcurrent protection circuits, wherein the inductor limits transient fault currents and reduces voltage spikes during circuit disconnection.

10. The electrical isolation system of claim 9, wherein:
the first redundant overcurrent protection circuit includes a first normally closed switch that includes an input side and a power side, the input side is arranged between the inductor and a first battery terminal of the battery, and the power side is arranged between a first chassis-grounded reed element and the chassis;
the overcurrent protection switch is arranged between a second battery terminal of the battery and the second redundant overcurrent protection circuit; and
the second redundant overcurrent protection circuit includes a second normally closed switch that includes an input side and a power side, the input side is arranged between the overcurrent protection switch and the inductor, and the power side is arranged between a second chassis-grounded reed element and the chassis,
wherein each switch and reed element pair operates independently to detect and interrupt fault currents on both battery terminals.

11. The electrical isolation system of claim 10, wherein the first battery terminal is a positive terminal of the battery, and the second battery terminal is a negative terminal of the battery, thereby enabling symmetrical protection of both high and low potential ends of the high voltage batter circuit.

12. The electrical isolation system of claim 10, wherein the first and second chassis-grounded reed elements are reed relays, each capable of independently breaking the current path when a magnetic field from leakage current energizes a relay coil.

13. The electrical isolation system of claim 10, further comprising a first chassis-grounded resistor arranged between the first battery terminal and a chassis ground and a second chassis-grounded resistor that is arranged between the second battery terminal and the chassis ground, wherein the first chassis-grounded reed element is a first reed switch that is connected to the first chassis-grounded resistor and the second chassis-grounded reed element is a second reed switch that is connected to a second chassis grounded resistor, wherein the resistors establish controlled current leakage paths to enable fault detection without compromising normal operation.

14. The electrical isolation system of claim 9, wherein the overcurrent protection switch is a first overcurrent protection switch, and wherein the electrical isolation system further includes a second overcurrent protection switch, each of the first overcurrent protection switch and the first redundant overcurrent protection circuit is arranged at a first battery terminal of the battery, and each of the second overcurrent protection switch and the second redundant overcurrent protection circuit is arranged at a second battery terminal of the battery, wherein the system provides dual-layer overcurrent protection at both battery poles for improved system robustness during isolation faults.

15. An energy storage system, comprising:
a high voltage battery circuit; and
an electrical isolation system for the high voltage battery circuit in an electrified vehicle, the electrical isolation system mounted to a chassis of the electrified vehicle and comprising:
an overcurrent protection element that is configured to be responsive to leakage current present in the high voltage battery circuit by breaking the high voltage battery circuit and
first and second redundant overcurrent protection circuits that are configured to be responsive to leakage current present in the high voltage battery circuit in a manner that is different from the overcurrent protection element to break the high voltage battery circuit such that the first and second redundant overcurrent protection circuits are more responsive in one or more fault modes of the electrified vehicle than is the overcurrent protection element alone.

16. The energy storage system of claim 15, wherein the first redundant overcurrent protection circuit is arranged at a first battery terminal of the battery, and the second redundant overcurrent protection circuit is arranged at a second battery terminal of the battery, such that the system remains operable even in case of unidirectional fault current on either battery terminal, wherein the overcurrent protection element is configured to be actuated based on a control signal generated by a vehicle control system in response to detection of a leakage current exceeding a predefined threshold; wherein each of the first and second redundant overcurrent protection circuits includes at least one electromechanical or magnetic component configured to respond passively to leakage current without requiring software-based control; wherein each of the first and second redundant overcurrent protection circuits is configured to open the high voltage battery circuit independently of the vehicle control system, including during control system failure, software crash, or contactor malfunction; and wherein the electrical isolation system provides a hardware-based secondary safety layer configured to mitigate electrical isolation faults even in the absence of software intervention.

17. The energy storage system of claim 15, wherein the overcurrent protection element is a first overcurrent protection switch, and wherein the electrical isolation system further includes a second overcurrent protection switch, each of the first overcurrent protection switch and the first redundant overcurrent protection circuit is arranged at a first battery terminal of a battery, and each of the second overcurrent protection switch and the second redundant overcurrent protection circuit is arranged at a second battery terminal of the battery, thereby enabling mirrored and redundant protection architecture for high-voltage energy systems.

18. A method of mitigating loss of isolation in a battery circuit of a high-voltage system in an electrified vehicle, the method comprising:
responding to leakage current present in the battery circuit by breaking the battery circuit using an overcurrent protection switch in the battery circuit, and
responding, independently to the overcurrent protection switch, to leakage current present in the battery circuit by breaking the battery circuit using a redundant overcurrent protection circuit in the battery circuit such that the redundant overcurrent protection circuit is more responsive in one or more fault modes of the electrified vehicle than is the overcurrent protection switch alone.

19. The method of claim 18, wherein the one or more fault modes in which the redundant overcurrent protection circuit is more responsive than is the overcurrent protection switch alone includes failure of the overcurrent protection switch, such that fault clearance is ensured even in the absence of active system control or communication, the method further comprising:
actuating the overcurrent protection switch based on a control signal generated by a vehicle control system in response to detection of leakage current exceeding a predefined threshold.
including in the redundant overcurrent protection circuit at least one electromechanical or magnetic switching component configured to passively detect the leakage current and interrupt the battery circuit without requiring software-based control or communication signals.
configuring the redundant overcurrent protection circuit to respond in one or more fault conditions that impair or prevent actuation of the overcurrent protection switch, including control system failure, software malfunction, or actuator error.
providing a hardware-based secondary safety layer that maintains isolation fault protection even in the absence of control system functionality.

20. The method of claim 18, wherein responding to leakage current present in the battery circuit by breaking the battery circuit using the overcurrent protection switch includes receiving an indication to open the overcurrent protection switch in response to detecting a leakage current by a battery management system of the electrified vehicle, wherein the battery management system initiates active control logic to prevent unsafe conditions upon detection of isolation degradation.
